(19) United States
(12) Patent Application Publication
(10) Pub. No.: US 2010/0090623 A1
(43) Pub. Date: Apr. 15, 2010

(54) Electric motor drive system with bi-directional input and constant directional output

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/285,588

(22) Filed: Oct. 9, 2008

(51) Int. Cl. H02P 29/00; H02K 7/116

(52) U.S. Cl. 318/14

(57) ABSTRACT

The present invention discloses a system having a particular electric motor being able to do bi-directional rotational input having its output ends for providing output to the input ends of the constant directional output transmission device, while the constant rotational directional output is used to drive the loading wheel train via the output end of the constant directional output transmission device, wherein the user can operatively control the rotational direction of driving inputs, thereby the constant rotational output of different speed change ratio in different directions of driving inputs can be made via the constant directional output transmission device of different speed change ratios.

### BACKGROUND OF THE INVENTION

(a) Field of the Invention

The present invention discloses an electric motor being able to be driven by electric power from the power source through the electric motor operative control device to do bi-directional rotation of positive or reverse rotation for driving the input end of the constant directional output transmission device and further through the output end of the constant directional output transmission device to provide constant directional rotation output of different speed change ratio in different directions of driving inputs via the constant directional output transmission device with different speed change ratio for driving the loading wheel trains; wherein the present invention can be applied in electric motor driven carriers such as electric bicycles, electric motorcycles, electric vehicles, or electric driven industry machinery.

(b) Description of the Prior Art

For the speed change output of the conventional electric motor drive system, except for controlling the electric motor to change speed, it usually has to be achieved by CVT or gear shift, which has drawbacks of complicated structures, high costs and low transmission efficiency.

### SUMMARY OF THE INVENTION

The present invention discloses an electric motor drive system having a particular electric motor being able to do bi-directional rotational input having its output ends for providing output to the input ends of the constant directional output transmission device, while the constant rotational directional output is used to drive the loading wheel train via the output end of the constant directional output transmission device, wherein the user can operatively control the rotational direction of the electric motor so as to change the driving input directions, thereby the constant rotational output of different speed change ratio in different directions of driving inputs can be made via the constant directional output transmission device having different speed change ratios.

### BRIEF DESCRIPTION OF THE DRAWINGS

FIG. 1 is a basic block schematic view of the electric motor drive system of the present invention with bi-directional input and constant directional output.

FIG. 2 is a block schematic view showing that the drive system in FIG. 1 is additionally installed with a transmission device (104) between the electric motor (101) and the constant directional output transmission device (102).

FIG. 3 is a block schematic view showing that the drive system in FIG. 1 is additionally installed with a transmission device (104) between the constant directional output transmission device (102) and the driven loading wheel train (103).

FIG. 4 is a block schematic view showing that the drive system in FIG. 1 is additionally installed with a transmission device (104) between the electric motor (101) and the constant directional output transmission device (102) as well as between the constant directional output transmission device (102) and the driven loading wheel train (103).

FIG. 5 is a basic block schematic view of the electric motor drive system with bi-directional input and constant directional output of the present invention being installed with an electric motor loading currents detection device.

FIG. 6 is a block schematic view showing that the drive system in FIG. 5 is additionally installed with a transmission device (104) between the electric motor (101) and the constant directional output transmission device (102).

FIG. 7 is a block schematic view showing that the drive system in FIG. 5 is additionally installed with a transmission device (104) between the constant directional output transmission device (102) and the driven loading wheel train (103).

FIG. 8 is a block schematic view showing that the drive system in FIG. 5 is additionally installed with a transmission device (104) between the electric motor (101) and the constant directional output transmission device (102) as well as between the constant directional output transmission device (102) and the driven loading wheel train (103).

### DESCRIPTION OF MAIN COMPONENT SYMBOLS

100: Power supply device
101: Electric motor
102: Constant directional output transmission device
103: Loading wheel train
104, 200: Transmission device
109: Electric motor loading currents detection device
110: Electric motor operative control device
111: Input device

### DETAILED DESCRIPTION OF THE PREFERRED EMBODIMENTS

The present invention discloses a drive system being able to do bi-directional rotation of positive or reverse rotation by electric motor for driving input end of the constant directional output transmission device and further through the output end of the constant directional output transmission device to provide constant directional rotation output of different speed change ratio in different directions of driving inputs via the constant directional output transmission device of different speed change ratio for driving the loading wheel trains, wherein the present invention can be applied in electric motor driven carriers such as electric bicycles, electric motorcycles, electric vehicles, or electric driven industry machinery.

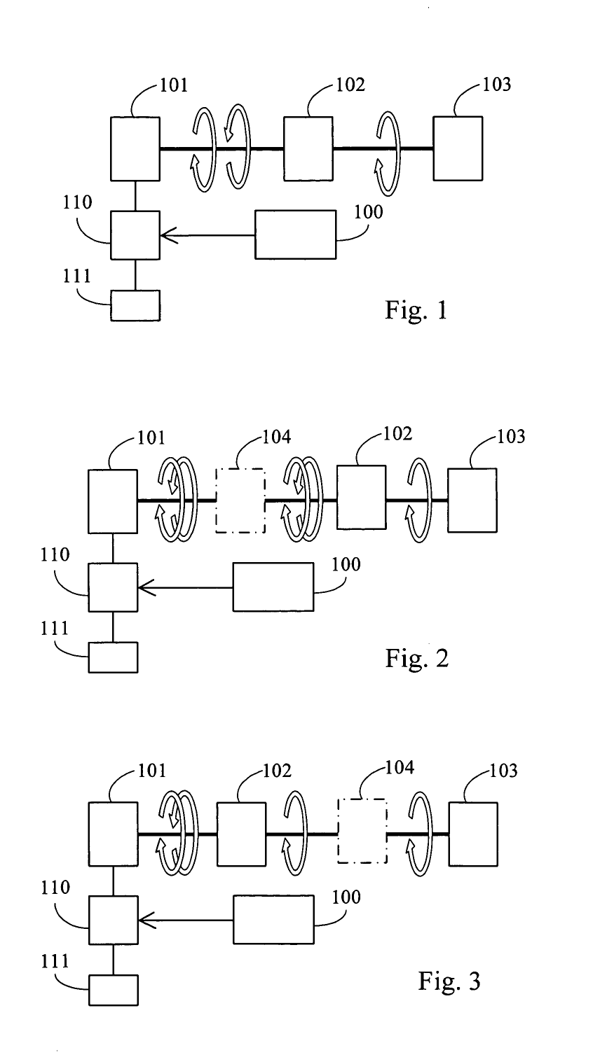

FIG. 1 is a basic block schematic view of the electric motor drive system of the present invention with bi-directional input and constant directional output.

FIG. 2 is a block schematic view showing that the drive system in FIG. 1 is additionally installed with a transmission device (104) between the electric motor (101) and the constant directional output transmission device (102).

FIG. 3 is a block schematic view showing that the drive system in FIG. 1 is additionally installed with a transmission device (104) between the constant directional output transmission device (102) and the driven loading wheel train (103).

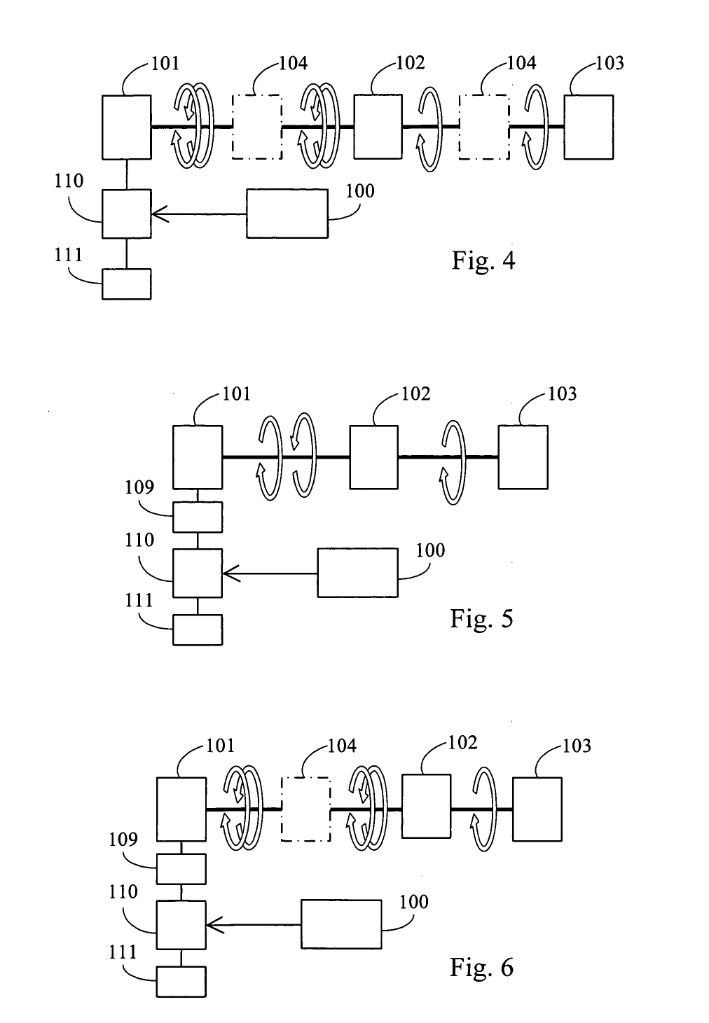

FIG. 4 is a block schematic view showing that the drive system in FIG. 1 is additionally installed with a transmission device (104) between the electric motor (101) and the constant directional output transmission device (102) as well as between the constant directional output transmission device (102) and the driven loading wheel train (103).

As shown in the FIGS. 1˜4, for the electric motor drive system with bi-directional input and constant directional output, the electric power from the power supply device (100) is subject to the operative signal or commands of the input device (111) via the electric motor operative control device (110) to drive the electric motor (101) in the first driven rotational direction or in the second driven rotational direction of contrary rotational direction, wherein the rotational kinetic energy output from the output end of the electric motor (101) is directly or through the transmission device (104) provided to the input end of the constant directional output transmission device (102), thereby by means of the constant directional output transmission device of different speed change ratio to output the rotational kinetic energy in constant rotational direction of different speed change ratio in different directions of driving inputs, and further to drive the loading wheel train (103) as shown in FIG. 1˜FIG. 4, wherein:

The electric motor (101): It is comprised of AC or DC, brushless or brushed, synchronous or asynchronous operated electric power driven electric motor, and can be operated in both positive direction and reverse direction;

Electric motor operative control device (110): it is constituted by dynamo-electric components or devices, or solid state electronic components or device, or the control circuits having microprocessor and associate operative software for inputting AC or DC power from the utility power source or the generator, or inputting electric power from the power supply device (100) such as fuel battery, primary battery, or charge/discharge secondary battery, thereby to operatively control the on/off, rotational direction, rotational speed, torque to the electric motor (101), or provide over-voltage or over-currents protection to the electric motor (101);

Input device (111): it issues signals or commands to the electric motor operative control device (110) for operatively controlling or setting the on/off, rotational direction, rotational speed, torque to the electric motor (101);

The input kinetic energy of the first driven rotational direction and the second driven rotational direction from the electric motor (101) is for driving the input end of the constant directional output transmission device (102);

The first driven rotational direction is contrary to the second driven rotational direction;

The constant directional output transmission device (102): The constant directional output transmission device (102) directly receives or is through the transmission device (104) to receive kinetic energy in different rotational direction from the electric motor (101) so as to provide kinetic energy output in constant rotational direction; wherein the internal transmission components of the constant directional output transmission device (102) are constituted by one or more than one transmission components of the 1) gear train; or 2) friction wheel train; or 3) chain and chain sprocket train; or 4) belt and belt wheel train; or 5) transmission crankshaft and wheel train; or 6) fluid transmission device; or 7) electromagnetic transmission device, etc., wherein if the constant directional output transmission device (102) is driven by the inputs of the first driven rotational direction and the second driven rotational direction in different rotational directions, the speed ratio of the constant directional rotation between the one at the input end and the one at the output end is the same or different or a variable speed ratio;

The loading wheel train (103): It is the wheel train type load being directly driven by the constant directional output transmission device (102) or being driven in the single constant directional rotation via the transmission device (104).

The electric motor drive system with bi-directional input and constant directional output of the present invention can be further installed with a transmission device between the constant directional output transmission device (102) and the loading wheel train (103), or between the electric motor (101) and the constant directional output transmission device (102), or between the electric motor (101) and the constant directional output transmission device (102) as well as between the constant directional output transmission device (102) and the loading wheel train (103);

FIG. 2 is a block schematic view showing that the drive system in FIG. 1 is additionally installed with a transmission device (104) between the electric motor (101) and the constant directional output transmission device (102).

FIG. 3 is a block schematic view showing that the drive system in FIG. 1 is additionally installed with a transmission device (104) between the constant directional output transmission device (102) and the driven loading wheel train (103).

FIG. 4 is a block schematic view showing that the drive system in FIG. 1 is additionally installed with a transmission device (104) between the electric motor (101) and the constant directional output transmission device (102) as well as between the constant directional output transmission device (102) and the driven loading wheel train (103).

The transmission device (104): The transmission device (104) is constituted by the automatic or electric motor operated stepped or stepless variable speed transmission device.

For the electric motor drive system with bi-directional input and constant directional output of the present invention, the input device (111) is manually operated to through the electric motor operative control device (110) operatively control the rotational direction of the electric motor (101).

In addition, the electric motor drive system with bi-directional input and constant directional output of the present invention can be additional installed with an electric motor loading currents detection device (109), thereby to automatically switch the output speed ratio according to the loading currents;

FIG. 5 is a basic block schematic view of the electric motor drive system with bi-directional input and constant directional output of the present invention being installed with an electric motor loading currents detection device.

FIG. 6 is a block schematic view showing that the drive system in FIG. 5 is additionally installed with a transmission device (104) between the electric motor (101) and the constant directional output transmission device (102).

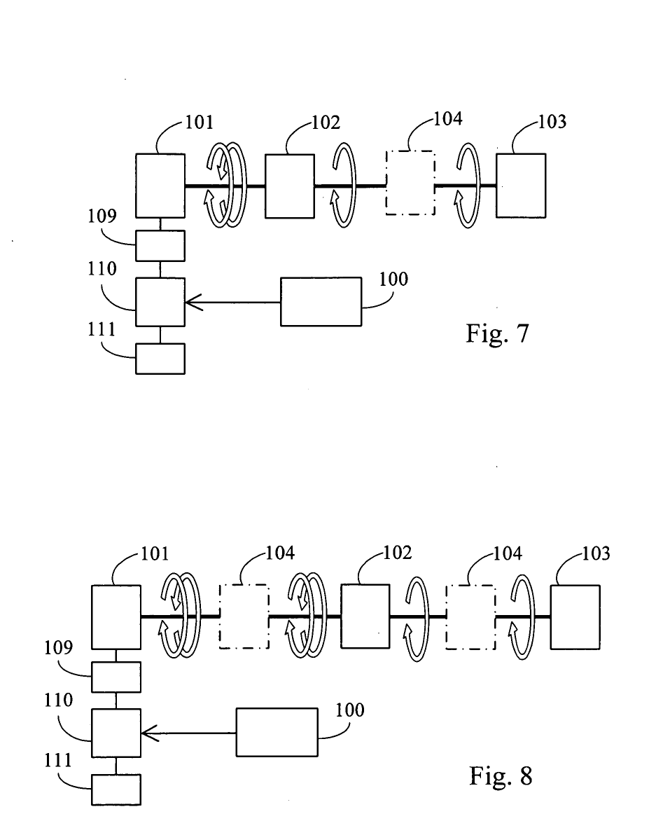

FIG. 7 is a block schematic view showing that the drive system in FIG. 5 is additionally installed with a transmission device (104) between the constant directional output transmission device (102) and the driven loading wheel train (103).

FIG. 8 is a block schematic view showing that the drive system in FIG. 5 is additionally installed with a transmission device (104) between the electric motor (101) and the constant directional output transmission device (102) as well as between the constant directional output transmission device (102) and the driven loading wheel train (103).

As shown in aforementioned FIGS. 5˜8, the electric motor drive system with bi-directional input and constant directional output of the present invention is further installed with an electric motor loading currents detection device (109), wherein the electric motor loading currents detection device (109) can be comprised of various buck/step down type current detection device, or electromagnetic effect induction type current detection device, or magnetic detecting type current detection device, or heat accumulated type current detection device for detecting loading currents of the electric motor (101), thereby feedback to the electric motor operative control device (110), wherein when the loading currents of the electric motor exceeds the predetermined value and the status exceeds the preset time, the signals from the electric motor loading currents detection device (109) is transmitted to the input device (111) or the electric motor operative control device (110) so as to change the rotational direction of the electric motor (101) and further change the speed ratio of the constant directional output transmission device (102) to a relatively enlarged deduction ratio to increase the output in the same rotational direction of the output rotational torque to further drive the load.

When the loading currents of the electric motor (101) return and drop below the predetermined value, the following two methods can be operated to make the electric motor back to the normal status, including:
1) By manually control the input device (111) to operatively control the electric motor operative control device (110) to enable the electric motor (101) returning to the original rotational direction, thereby driving the load at original speed ratio; or
2) When the electric motor loading currents detection device (109) detects currents dropping to the predetermined value, by means of the electric motor operative control device (110) to automatically select the rotational speed which is not only capable of driving the load at that time, but also capable of outputting corresponding power volume according to the variation of the speed ratio so as to drive the load fluently without pauses or unexpected accelerations, thereby to drive the electric motor (101) being fluently operated in the original rotational direction.

If the electric motor drive system with bi-directional input and constant directional output of the present invention further requires to perform constant directional output in different driving directions, it can be achieved by one of following methods:
1) By means of the electric motor operative control device (110) to operatively control the initial driving direction of the electric motor (101); or
2) A motor direction switch is additionally installed to manually switch the initial rotational direction of the motor; or
3) One of the transmission devices (104) is constituted by the transmission device with functions of mechanically switching rotational directions of the output and changing the speed ratio for switching the rotational direction of output.

1. An electric motor drive system with bi-directional input and constant directional output is subject to the operative signal or commands of the input device (111) to supply the electric power from the power supply device (100) via the electric motor operative control device (110) to drive the electric motor (101) in the first driven rotational direction or in the second driven rotational direction of contrary rotational direction, wherein the rotational kinetic energy output from the output end of the electric motor (101) is directly or through the transmission device (104) provided to the input end of the constant directional output transmission device (102), thereby by means of the constant directional output transmission device of different speed change ratio to output the rotational kinetic energy in constant rotational direction of different speed change ratio in different directions of driving inputs, and further to drive the loading wheel train (103), wherein
The electric motor (101): It is comprised of AC or DC, brushless or brushed, synchronous or asynchronous operated electric power driven electric motor, and can be operated in both positive direction and reverse direction;
Electric motor operative control device (110): it is constituted by dynamo-electric components or devices, or solid state electronic components or device, or the control circuits having microprocessor and associate operative software for inputting AC or DC power from the utility power source or the generator, or inputting electric power from the power supply device (100) such as fuel battery, primary battery, or charge/discharge secondary battery, thereby to operatively control the on/off, rotational direction, rotational speed, torque to the electric motor (101), or provide over-voltage or over-currents protection to the electric motor (101);
Input device (111): it issues signals or commands to the electric motor operative control device (110) for operatively controlling or setting the on/off, rotational direction, rotational speed, torque to the electric motor (101);
The input kinetic energy of the first driven rotational direction and the second driven rotational direction from the electric motor (101) is for driving the input end of the constant directional output transmission device (102);
The first driven rotational direction is contrary to the second driven rotational direction;
The constant directional output transmission device (102): The constant directional output transmission device (102) directly receives or is through the transmission device (104) to receive kinetic energy in different rotational direction from the electric motor (101) so as to provide kinetic energy output in constant rotational direction; wherein the internal transmission components of the constant directional output transmission device (102) are constituted by one or more than one transmission components of the 1) gear train; or 2) friction wheel train; or 3) chain and chain sprocket train; or 4) belt and belt wheel train; or 5) transmission crankshaft and wheel train; or 6) fluid transmission device; or 7) electromagnetic transmission device, etc., wherein if the constant directional output transmission device (102) is driven by the inputs of the first driven rotational direction and the second driven rotational direction in different rotational directions, the speed ratio of the constant directional rotation between the one at the input end and the one at the output end is the same or different or a variable speed ratio;
The loading wheel train (103): It is the wheel train type load being directly driven by the constant directional output transmission device (102) or being driven in the single constant directional rotation via the transmission device (104).

2. An electric motor drive system with bi-directional input and constant directional output as claimed in claim 1, wherein it is further installed with a transmission device between the constant directional output transmission device (102) and the loading wheel train (103), or between the electric motor (101) and the constant directional output transmission device (102), or between the electric motor (101) and the constant directional output transmission device (102) as well as between the constant directional output transmission device (102) and the loading wheel train (103).

3. An electric motor drive system with bi-directional input and constant directional output as claimed in claim 2, wherein the transmission device (104) is constituted by the automatic or electric motor operated stepped or stepless variable speed transmission device.

4. An electric motor drive system with bi-directional input and constant directional output as claimed in claim 1, wherein an electric motor loading currents detection device (109) is further installed and wherein the electric motor loading currents detection device (109) can be comprised of various buck/step down type current detection device, or electromagnetic effect induction type current detection device, or magnetic detecting type current detection device, or heat accumulated type current detection device for detecting loading currents of the electric motor (101), thereby feedback to the electric motor operative control device (110), wherein when the loading currents of the electric motor exceeds the predetermined value and the status exceeds the preset time, the signals from the electric motor loading currents detection device (109) is transmitted to the input device (111) or the electric motor operative control device (110) so as to change the rotational direction of the electric motor (101) and further change the speed ratio of the constant directional output transmission device (102) to a relatively enlarged deduction ratio to increase the output in the same rotational direction of the output rotational torque to further drive the load.

5. An electric motor drive system with bi-directional input and constant directional output as claimed in claim 4, wherein when the loading currents of the electric motor (101) return and drop below the predetermined value, by manually control the input device (111) the electric motor operative control device (110) can be operatively controlled to enable the electric motor (101) returning to the original rotational direction, thereby driving the load at original speed ratio.

6. An electric motor drive system with bi-directional input and constant directional output as claimed in claim 4, wherein when the loading currents of the electric motor (101) return and drop below the predetermined value, by means of the electric motor operative control device (110) at the time the electric motor loading currents detection device (109) detects currents dropping to the predetermined value to automatically select the rotational speed which is not only capable of driving the load at that time, but also capable of outputting corresponding power volume according to the variation of the speed ratio so as to drive the load fluently without pauses or unexpected accelerations, thereby to drive the electric motor (101) being fluently operated in the original rotational direction.

7. An electric motor drive system with bi-directional input and constant directional output as claimed in claim 1, wherein when it is further required to perform constant directional output in different driving directions it can be achieved by means of the electric motor operative control device (110) to operatively control the initial driving direction of the electric motor (101).

8. An electric motor drive system with bi-directional input and constant directional output as claimed in claim 1, wherein when it is further required to perform constant directional output in different driving directions it can be achieved by additionally installing a motor direction switch to manually switch the initial rotational direction of the motor.

9. An electric motor drive system with bi-directional input and constant directional output as claimed in claim 1, wherein when it is further required to perform constant directional output in different driving directions it can be achieved by providing one of the transmission devices (104) to be constituted by the transmission device with functions of mechanically switching rotational directions of the output and changing the speed ratio for switching the rotational direction of output.
